(19) United States
(12) Patent Application Publication
(10) Pub. No.: US 2026/0013453 A1
(43) Pub. Date: Jan. 15, 2026

(54) MICROALGAE CULTIVATION APPARATUS AND METHOD

(71) Applicant: ELECTRONICS AND TELECOMMUNICATIONS RESEARCH INSTITUTE, Daejeon (KR)

(72) Inventors: Kwang Hyo CHUNG, Daejeon (KR); You Jin KIM, Daejeon (KR); Yo Han CHOI, Daejeon (KR)

(21) Appl. No.: 19/223,459

(22) Filed: May 30, 2025

(30) Foreign Application Priority Data
Jul. 11, 2024 (KR) 10-2024-0091727

(51) Int. Cl. A01G 33/00; A01G 7/02

(52) U.S. Cl. CPC A01G 33/00; A01G 7/02

(57) ABSTRACT

The present invention relates to a microalgae cultivation apparatus and method. A microalgae cultivation apparatus includes a cultivation vessel which has a cultivation space for accommodating a culture medium and cultivates microalgae therein, a gas supply unit configured to supply gas to the cultivation vessel, a gas discharge portion configured to discharge gas that has passed through the culture medium of the cultivation vessel, a sensor unit installed inside the cultivation vessel, an actuator unit installed inside the cultivation vessel, a microalgae collection device configured to collect the microalgae cultured in the cultivation vessel, and a control device configured to control at least one of the gas supply unit, the gas discharge portion, and the actuator unit to generate an environment for cultivating the microalgae, collect cultivation information through the sensor unit, and control the microalgae collection device to collect the microalgae based on the collected cultivation information.

### CROSS-REFERENCE TO RELATED APPLICATION

This application claims priority to and the benefit of Korean Patent Application No. 10-2024-0091727, filed on Jul. 11, 2024, the disclosure of which is incorporated herein by reference in its entirety.

### BACKGROUND

### 1. Field of the Invention

The present invention relates to a microalgae cultivation apparatus and method which is capable of collecting and analyzing cultivation information of microalgae and collecting the microalgae based on an analysis result.

### 2. Description of Related Art

On Earth, a carbon fixation process is mostly accomplished through photosynthesis of plants and microorganisms. However, as fossil fuel use increases (which accounts for 75% of current energy demand), greenhouse gas emissions are rapidly increasing, and thus climate and environmental problems are being caused due to the greenhouse effect according to a limitation in natural carbon fixation. To solve these problems, there is a need for technologies for reducing carbon dioxide emissions and capturing and storing emitted carbon dioxide, and the development of carbon capture & storage technology (CCS) is being highlighted.

Existing carbon capture technologies are mainly applied to large-scale plants that use physical and chemical methods using carbon separation membranes, carbon capture reaction solutions, and the like. There is a limitation that the existing carbon capture technologies can only be applied to large-scale carbon emission facilities due to issues such as high facility introduction costs and operating costs.

The background technology of the present invention is disclosed in Korean Patent Publication No. 10-2015-0098403 (published on Aug. 28, 2015).

### SUMMARY OF THE INVENTION

The present invention is directed to providing a microalgae cultivation apparatus and method which is capable of collecting and analyzing cultivation information of microalgae and collecting microalgae based on an analysis result.

According to an aspect of the present invention, there is provided a microalgae cultivation apparatus including a cultivation vessel which has a cultivation space for accommodating a culture medium and cultivates microalgae therein, a gas supply unit configured to supply gas to the cultivation vessel, a gas discharge portion configured to discharge gas that has passed through the culture medium of the cultivation vessel, a sensor unit installed inside the cultivation vessel, an actuator unit installed inside the cultivation vessel, a microalgae collection device configured to collect the microalgae cultured in the cultivation vessel, and a control device configured to control at least one of the gas supply unit, the gas discharge portion, and the actuator unit to generate an environment for cultivating the microalgae, collect cultivation information through the sensor unit, and control the microalgae collection device to collect the microalgae based on the collected cultivation information.

The gas supply unit may include a gas pipe which is coupled to the cultivation vessel, has at least a portion located inside the cultivation vessel, and supplies external gas to the cultivation vessel, a gas sensing chamber which is installed outside the cultivation vessel and includes a gas measuring sensor configured to sense a state of gas flowing into the gas pipe, and a pneumatic pump installed outside the cultivation vessel and configured to allow the gas flowing into the gas pipe to flow out to the culture medium in the cultivation vessel.

The gas supply unit may further include an impurity removal filter installed at a front end portion of the gas sensing chamber outside the cultivation vessel and configured to remove impurities from the gas flowing into the gas pipe.

A lower area of the cultivation vessel may be filled with the culture medium including the microalgae, and an upper area of the cultivation vessel may be filled with the gas that has passed through the culture medium.

The sensor unit may include at least one of a temperature sensor, a dissolved oxygen sensor, a dissolved carbon sensor, a pH sensor, a humidity sensor, and a light sensor.

The actuator unit may generate the environment for cultivating the microalgae by operating at least one of a light source, a heater, a stirrer, an ultrasonic generator, and a pH regulator installed inside the cultivation vessel under control of the control device.

The control device may be connected to at least one of the gas supply unit, the sensor unit, the actuator unit, and the microalgae collection device in a wired manner.

The microalgae collection device may be installed at an upper portion of the cultivation vessel such that at least a portion of the microalgae collection device is located outside the cultivation vessel.

The microalgae collection device may include a housing, a filtering chamber installed inside the housing, a transfer tube formed to move the culture medium in the cultivation vessel to the filtering chamber, and a transfer pump installed outside the housing and configured to allow the culture medium to move to the filtering chamber through the transfer tube, and the filtering chamber may include a filter configured to filter the microalgae from the culture medium supplied through the transfer tube, and at least one collection port configured to move the culture medium, from which the microalgae have been removed through the filter, into the cultivation vessel.

The filter may be installed at a lower portion inside the filtering chamber, and a support may be installed below the filter and is installed in an area excluding the collection port.

The microalgae collection device may further include a filter supply roller installed inside the housing and configured to supply the filter to the filtering chamber, a filter collection roller installed inside the housing and configured to collect the filter of the filtering chamber, and a rotary motor installed at the filter collection roller and configured to move the filter from the filter supply roller to the filter collection roller under control of the control device.

The control device may calculate a total amount of the microalgae filtered by the filter based on a concentration of the microalgae included in the culture medium in the cultivation vessel and a flow rate of the transfer pump, and when the calculated total amount of the microalgae is greater than or equal to a preset standard capacity, may operate the rotary motor to move the filter in the filtering chamber so that the filter of the filtering chamber is replaced.

When a concentration of the microalgae included in the cultivation information is greater than or equal to a preset standard concentration, the control device may control the microalgae collection device to collect the microalgae.

The microalgae collection device may be installed inside the cultivation vessel and connected to the control device in a wireless manner, and at least one of the gas supply unit, the sensor unit, and the actuator unit may be connected to the control device in a wired manner.

The microalgae collection device may include a housing, a buoyancy material installed below the housing and configured to allow the housing to float above the culture medium, a filtering chamber installed inside the housing, a transfer tube formed to move the culture medium in the cultivation vessel to the filtering chamber, a transfer pump installed outside the housing and configured to allow the culture medium to move to the filtering chamber through the transfer tube, and a wireless controller configured to perform wireless communication with the control device and receive a control signal for controlling the rotary motor and the transfer pump in the filtering chamber from the control device in a wireless manner, and the filtering chamber may include a filter configured to filter the microalgae from the culture medium supplied through the transfer tube, and at least one collection port configured to move the culture medium, from which the microalgae have been removed through the filter, into the cultivation vessel.

The filter may be installed at a lower portion inside the filtering chamber, and a support may be installed below the filter and may be installed in an area excluding the collection port.

The microalgae collection device may include a filter supply roller installed inside the housing and configured to supply the filter to the filtering chamber, a filter collection roller installed inside the housing and configured to collect the filter of the filtering chamber, and a rotary motor installed at the filter collection roller and configured to move the filter from the filter supply roller to the filter collection roller under control of the control device.

According to another aspect of the present invention, there is provided a microalgae cultivation method including controlling, by a control device, at least one of a gas supply unit and an actuator unit to generate a microalgae cultivation environment, determining whether a preset microalgae collection condition is satisfied by analyzing, by the control device, cultivation information collected through a sensor unit, and when the microalgae collection condition is satisfied, controlling, by the control device, a microalgae collection device to collect microalgae.

In the determining, when a concentration of the microalgae of the cultivation information is greater than or equal to a preset standard concentration, the control device may determine that the microalgae collection condition is satisfied.

The controlling may further include moving, by the control device, a culture medium cultured in a cultivation vessel to a filtering chamber of the microalgae collection device and performing control such that the microalgae is filtered from the culture medium through a filter installed at a lower portion of the filtering chamber, when a total amount of the microalgae filtered by the filter is greater than or equal to a preset standard capacity, moving, by the control device, the filter of the filtering chamber to a filter collection roller to replace the filter of the filtering chamber, and when the filter of the filter supply roller is exhausted, outputting, by the control device, notification information for collecting the microalgae from the filter wound around the filter collection roller.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a configuration of a microalgae cultivation apparatus according to one embodiment of the present invention;

FIG. 2 is a view illustrating a wired microalgae cultivation apparatus according to one embodiment of the present invention;

FIG. 3 is a view illustrating a microalgae collection device shown in FIG. 2;

FIG. 4 is a view illustrating a wireless microalgae cultivation apparatus according to another embodiment of the present invention;

FIG. 5 is a view illustrating a microalgae collection device shown in FIG. 4;

FIG. 6 is a schematic block diagram illustrating a configuration of a control device according to one embodiment of the present invention;

FIG. 7 is a view for describing a microalgae cultivation method according to one embodiment of the present invention; and

FIG. 8 is a flowchart for describing a microalgae collection method according to one embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, embodiments of a microalgae cultivation apparatus and method according to one embodiment of the present invention will be described.

Due to the depletion of fossil fuels, research on alternative energy sources is being conducted, and interest in microalgae is increasing because microalgae can be used as an alternative energy source.

Microalgae are single-celled photosynthetic microorganisms that fix carbon dioxide through photosynthesis and synthesize organic materials. Biological carbon fixation methods using microalgae to capture carbon dioxide are emerging as an alternative to physical and chemical methods. Biofuel production using microalgae is so excellent that a production per unit area is 130 times that of soybeans, and byproducts of microalgae left after biofuel production may also be used as animal feed and plant fertilizer.

In addition, there is growing interest is in the use of microalgae for fixing carbon dioxide as well as treating nutrient salts of nitrogen, phosphorus, and the like which cause eutrophication.

In addition, microalgae are being used to produce high value-added raw materials that can be used in foods, cosmetics, and pharmaceuticals.

In this way, photobiological reaction methods and apparatuses for cultivating (growing) microalgae are being proposed to cultivate (grow) microalgae to perform carbon and nutrient salt treatment, biofuel production, high value-added raw material production, feed and fertilizer production, or the like.

To achieve large-scale photobiological reactions of microalgae, natural open reactors such as reservoirs, retention tanks, and waterway pond systems are used. However, these natural open reactors have disadvantages in that large areas are consumed, photosynthetic efficiency is changed due to changes in growth temperature and light radiance according to natural environments such as air temperature and amount of sunlight, water is evaporated, and light penetration is limited according to a depth.

Artificial closed photobioreactors are being researched to overcome the disadvantages of the natural open reactors, increase photosynthetic efficiency, and cultivate and produce microalgae under stable optimal conditions.

As compared to other microorganisms, the growth of microalgae is changed very complexly and sensitively because respective cultivation factors, such as a strain concentration, a temperature, light supply, pH, nutrient supply, gas supply, and culture medium circulation, mutually affects other cultivation factors. Accordingly, in order to provide reproducible cultivation conditions, there is a need for a controllable photobioreactor.

In addition, there are about 40,000 species of microalgae on Earth, and respective algae require different cultivation environments. When a cultivation environment is generated under various conditions, the growth rate of algae and the quality and ratio of produced materials change, and thus a photobioreactor is necessary to find the optimal conditions for obtaining useful materials.

Photobioreactors may be classified into vertical tube type, flat plate type, horizontal tube type, spiral type, stirred tank type, and hybrid type photobioreactors according to shapes. Among them, the flat plate photobioreactor may have advantages of uniform light penetration and a high ratio of a surface area to a reactor volume and thus, when photosynthetic microalgae are cultivated, may use light energy more efficiently than other types of photobioreactors such as circular photobioreactors.

Photobioreactors for microalgae cultivation are divided into batch type and continuous type photobioreactors according to cultivation methods. The batch type photobioreactor is a system that supplies a certain amount of culture medium and grows and harvests microalgae. The batch type photobioreactor has an advantage in that the cultivation (growth) of microalgae may be checked step by step to harvest microalgae, but has a disadvantage in that it is difficult to arbitrarily specify desired cultivation conditions and reproducibility is low. The continuous type photobioreactor is a system that continuously harvests microalgae by constantly maintaining a volume of a culture medium and a concentration of microalgae. The continuous type photobioreactor has an advantage in that it is possible to maintain specific conditions reproducibly for a long time, but has a disadvantage in that a large number of maintenance equipment including sensors is required to maintain the system.

To commercialize useful products as in carbon dioxide removal or biofuel production using microalgae, there is a need for high-density cultivation, mass cultivation, or high-density mass cultivation of photosynthetic microorganisms. Therefore, there is an urgent need for the development of a cultivation technology that enables high-density cultivation at low costs and also is easy to scale up, as well as a technology related to the construction of large-scale cultivation facilities.

As described above, in conventional photobioreactors, in order to improve the growth efficiency of microalgae, methods of improving the growth efficiency of microalgae, including changes in microalgae growth conditions according to changes in light sources, application of bio-fouling prevention structures, stable material transfer methods between microalgae and gas, changes in container materials and shapes, and growth monitoring methods, have been proposed.

However, photobioreactors proposed so far still have limitations in commercialization due to economic issues such as low efficiency and high maintenance costs, as well as environmental issues.

Accordingly, the present invention proposes a microalgae cultivation apparatus and method in which a cultivation (growth) situation is continuously monitored through a sensor unit to optimize cultivation (growth) conditions and obtain high efficiency and economic feasibility, and when specific cultivation (growth) conditions are satisfied through real-time cultivation (growth) information analysis, microalgae are allowed to be collected.

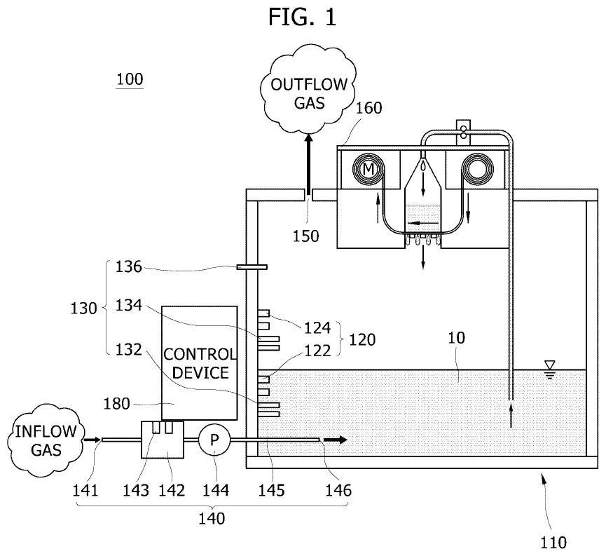

FIG. 1 is a view illustrating a configuration of a microalgae cultivation apparatus according to one embodiment of the present invention.

Referring to FIG. 1, a microalgae cultivation apparatus 100 according to one embodiment of the present invention includes a cultivation vessel 110, a sensor unit 120, an actuator unit 130, a gas supply unit 140, a gas discharge portion 150, a microalgae collection device 160, and a control device 180.

The cultivation vessel 110 may have a cultivation space for accommodating a culture medium 10 and may culture microalgae therein. Here, the culture medium 10 may include microalgae.

The cultivation vessel 110 may have an empty internal space, and the internal space may accommodate the culture medium 10. The cultivation vessel 110 may provide the cultivation space for cultivating microalgae.

The cultivation vessel 110 may be a closed housing that is isolated from the external atmosphere. The cultivation vessel 110 may be manufactured in any one shape of a box shape, a container shape, a raceway shape, a rectangular parallelepiped shape, a barrel shape, a cylinder shape, and a polygonal column shape, but the present invention is not necessarily limited thereto. Housings with various shapes that can be used in the art may be applied to the cultivation vessel 110.

The cultivation vessel 110 may be formed to have a waterproof structure such that the culture medium 10 does not easily leak. In addition, the cultivation vessel 110 may be made of a material having excellent mechanical strength, water resistance, and chemical resistance.

The cultivation vessel 110 may be made of at least one selected from the group consisting of plastic, concrete, iron, reinforced glass, polycarbonate, and acrylic. In addition, the cultivation vessel 110 may be made of a transparent material. The cultivation vessel 110 may be made of acrylic and stainless steel. The cultivation vessel 110 may be made of a transparent material and may have the cultivation space therein, and any material may be applied without limitation as long as the culture medium 10 may be accommodated in the material to culture microalgae. However, the present invention is not necessarily limited thereto, and various materials that can be used in the art may be used.

The capacity of the cultivation vessel 110 may be selectively applied according to the type and amount of microalgae to be cultured, and the present invention is not limited to the example described above.

A lower area of the cultivation vessel 110 may be filled with the culture medium 10 including the microalgae, and an upper area of the cultivation vessel 110 may be filled with gas that has passed through the culture medium 10.

The sensor unit 120 may be installed inside the cultivation vessel 110 and may measure a quantity of light, a temperature, pH, a concentration of microalgae, an oxygen concentration, a carbon concentration, humidity, or the like.

The sensor unit 120 may include a first sensor unit 122 installed in an area of the cultivation vessel 110 filled with the culture medium 10, and a second sensor unit 124 installed in an area of the cultivation vessel 110 filled with gas.

The first sensor unit 122 may measure a temperature, oxygen, carbon, pH, a concentration of microalgae, or the like of the culture medium 10 and may be referred to as a culture medium measuring sensor.

The first sensor unit 122 may include, for example, a temperature sensor, a dissolved oxygen sensor, a dissolved carbon sensor, a pH sensor, a light sensor, or the like.

The second sensor unit 124 may measure a temperature of gas, oxygen, carbon, humidity, or the like and may be referred to as a gas measuring sensor 143.

The second sensor unit 124 may include, for example, a temperature sensor, an oxygen sensor, a carbon dioxide sensor, a humidity sensor, a light sensor, or the like.

The actuator unit 130 may be installed inside the cultivation vessel 110 and may be driven under the control of the control device 180.

The actuator unit 130 may generate an environment for culturing microalgae by operating at least one of a light source, a heater, a stirrer, an ultrasonic generator, and a pH regulator 136 installed in the cultivation vessel 110 under the control of the control device 180.

The actuator unit 130 may include a first actuator unit 132 installed in the area of the cultivation vessel 110 filled with the culture medium 10, and a second actuator unit 134 installed in the area of the cultivation vessel 110 filled with gas.

The first actuator unit 132 may be installed to be exposed at the culture medium 10 and may operate a heater, a light source, a stirrer, an ultrasonic generator, or the like.

The second actuator unit 134 may be installed to be exposed at gas and may operate a heater, a light source, a pH regulator 136, or the like.

The light source may radiate light onto the cultivation vessel 110. As the light source, sunlight, a light-emitting diode (LED), a fluorescent lamp, a halogen lamp, an incandescent lamp, or the like may be applied, and a light guide mechanism may be applied such that uniform light may be radiated onto the culture medium 10 inside the cultivation vessel 110.

For example, the light source may include a plurality of LED lamps and may be provided in a panel form. A quantity of light of the light source may be selectively provided according to types of microalgae, cultivation conditions, and amounts of cultured microalgae. As an example, when the light source is provided as an LED lamp, a quantity of light supplied to the cultivation vessel 110 may be adjusted by controlling an individual quantity of light of the LED lamp.

The pH regulator 136 may be installed by perforating a wall of the cultivation vessel 110 and may be installed to supply an acid or base component and the culture medium 10 to control the pH of the culture medium 10.

The gas supply unit 140 may supply gas to the cultivation vessel 110. Light and carbon dioxide are absolutely necessary for photosynthesis of microalgae. The gas supply unit 140 may supply gas including carbon dioxide to the cultivation vessel 110.

The gas supply unit 140 may include a gas pipe 145, a gas sensing chamber 142, and a pneumatic pump 144.

The gas pipe 145 may be connected to the cultivation vessel 110, may have at least a portion located inside the cultivation vessel 110, and may supply external gas to the cultivation vessel 110.

A portion of the gas pipe 145 may be exposed to the outside of the cultivation vessel 110, and another portion thereof may be located in the internal space of the cultivation vessel 110 in which the culture medium 10 is placed.

The gas pipe 145 may include a gas inlet port 141 through which external gas flows in, and a gas supply port 146 through which externally supplied air is supplied to the culture medium 10. Gas supplied through the gas supply port 146 may be supplied in the form of bubbles.

The pneumatic pump 144 may be installed outside the cultivation vessel 110 and may allow gas flowing into the gas pipe 145 to flow out to the culture medium 10 inside the cultivation vessel 110. The gas may flow in through the gas inlet port 141 by the operation of the pneumatic pump 144 and may move to the gas supply port 146 through the gas pipe 145 to be supplied to the culture medium 10 inside the cultivation vessel 110.

In this case, the gas flowing in through the gas inlet port 141 may be atmospheric gas, specific gas of a gasbomber, exhaust gas, or the like, and thus impurities may be present in the inflowing gas.

Accordingly, the gas supply unit 140 may further include an impurity removal filter (not shown) for removing impurities from the inflowing gas. Here, impurities may refer to materials such as fine dust, NOₓ, and SOₓ that are harmful to the cultivation (growth) of microalgae.

The impurity removal filter may be installed at a front end portion of the gas sensing chamber 142 outside the cultivation vessel 110 and may remove impurities from inflowing gas.

The gas sensing chamber 142 may be installed outside the cultivation vessel 110 and may include a gas measuring sensor 143 for sensing a state of gas flowing into the gas pipe 145. That is, the gas sensing chamber 142 may be installed to sense a state of inflowing gas, and the gas measuring sensor 143 may be installed inside the gas sensing chamber 142. The gas measuring sensor 143 may measure a concentration of carbon dioxide, oxygen, NOₓ, SOₓ, or the like. Here, a concentration may refer to an amount per unit volume.

The gas supply unit 140 may supply gas including carbon dioxide in the form of bubbles to a space of the culture medium 10, thereby allowing the microalgae inside the culture medium 10 to absorb carbon dioxide as much as possible and maximize photosynthetic activity. In addition, thus, the cultivation efficiency of microalgae can be improved.

A portion of gas supplied to the culture medium 10 through the gas supply unit 140 may be consumed for photosynthesis by the culture medium 10 and changed into internal gas. The internal gas may be discharged from the cultivation vessel 110 through the gas discharge portion 150 by pressure formed inside the cultivation vessel 110.

The gas discharge portion 150 may discharge gas that has passed through the culture medium 10 of the cultivation vessel 110 to the outside.

The gas supplied through the gas supply unit 140 may pass through the culture medium 10 and move to an upper portion of the cultivation vessel 110. Thereafter, the gas located at the upper portion of the culture medium 10 inside the cultivation vessel 110 may be discharged to the outside through the gas discharge portion 150. The discharged gas may have a lower concentration of carbon dioxide than inflowing gas has. This is a result that the microalgae in the culture medium 10 uses a portion of carbon dioxide included in the inflowing gas for the action thereof.

The gas discharge portion 150 may be formed in the shape of a hole in the upper portion of the cultivation vessel 110.

The microalgae collection device 160 may operate under the control of the control device 180 and may collect microalgae cultured in the cultivation vessel 110. In this case, the microalgae collection device 160 may be connected to the control device 180 in a wired or wireless manner.

The installation location and configuration of the microalgae collection device 160 may differ according to whether the microalgae collection device 160 is connected to the control device 180 in a wired or wireless manner.

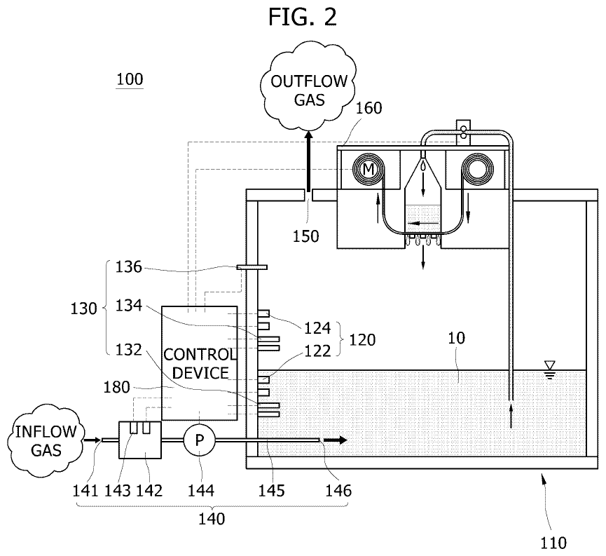

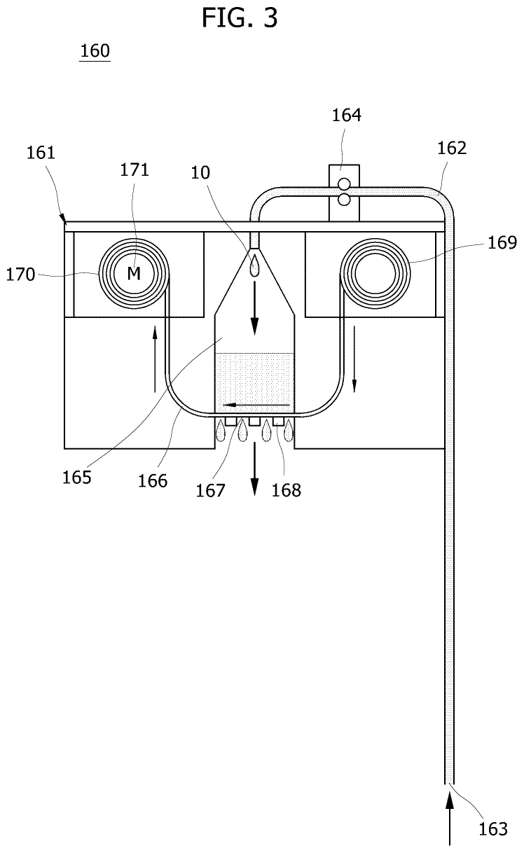

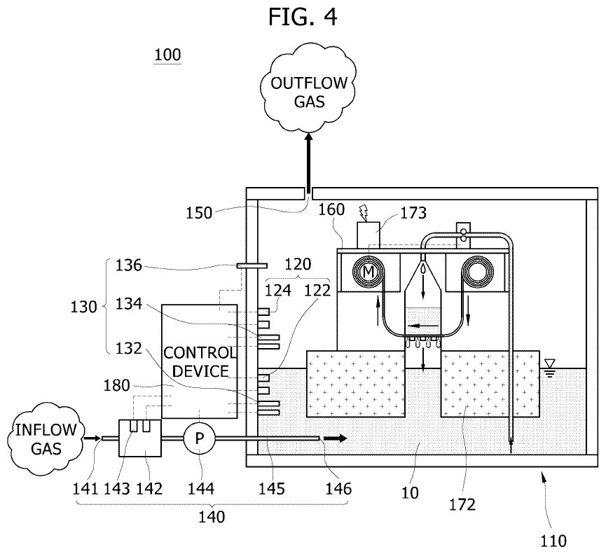

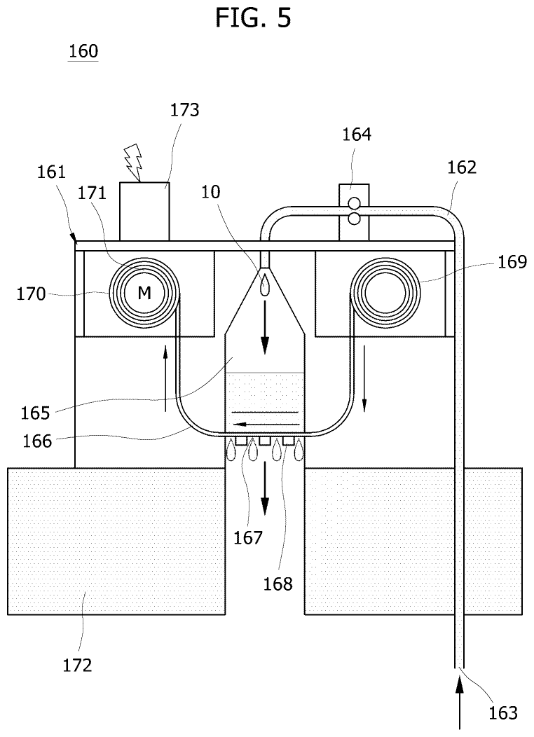

For a detailed description of a case in which the microalgae collection device 160 is connected to the control device 180 in a wired manner, reference is made to FIGS. 2 and 3, and for a detailed description of a case which the microalgae collection device 160 is connected to the control device 180 in a wireless manner, reference is made to FIGS. 4 and 5.

The control device 180 may control at least one of the gas supply unit 140, the gas discharge portion 150, and the actuator unit 130 to generate an environment for cultivating microalgae, may collect cultivation information through the sensor unit 120, and may control the microalgae collection device 160 to collect microalgae based on the collected cultivation information.

The control device 180 may monitor the cultivation information collected through the sensor unit 120 in real time to analyze the cultivation information in real time, and may operate the microalgae collection device 160 to collect microalgae when the cultivation information satisfies a preset microalgae collection condition. Here, the microalgae collection condition may include whether a concentration of microalgae in the culture medium 10 measured through the sensor unit 120 (for example, an optical sensor) is greater than or equal to a preset reference concentration.

The control device 180 may control one or more cultivation conditions of a quantity of light, a light source color, a light period, a temperature, pH, the pneumatic pump 144, a transfer pump 164, a rotary pump, a gas injection timing, a gas injection cycle, a gas discharge cycle, and a gas injection amount.

This control device 180 may be a computer or a small board, may analyze cultivation information collected through the sensor unit 120 by applying an intelligent analysis technology such as deep learning or machine learning, and may display cultivation information analysis results through an output module or transmit the cultivation information analysis results to a management server (not shown) through a communication network.

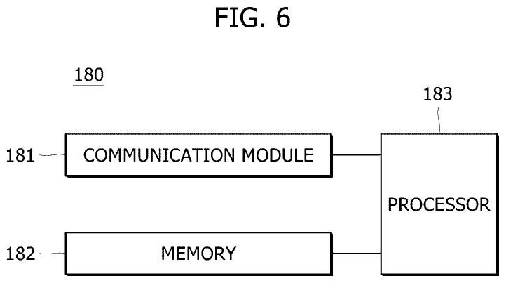

For a detailed description of the control device 180, reference is made to FIG. 6.

FIG. 2 is a view illustrating a wired microalgae cultivation apparatus according to one embodiment of the present invention. FIG. 3 is a view illustrating a microalgae collection device shown in FIG. 2.

Referring to FIG. 2, a wired microalgae cultivation apparatus 100 according to one embodiment of the present invention includes a cultivation vessel 110, a sensor unit 120, an actuator unit 130, a gas supply unit 140, a gas discharge portion 150, a microalgae collection device 160, and a control device 180.

Since the cultivation vessel 110 is the same as the cultivation vessel 110 of FIG. 1, a description thereof will be omitted.

The sensor unit 120, the actuator unit 130, the gas supply unit 140, and the microalgae collection device 160 may be connected to the control device 180 in a wired manner.

The sensor unit 120 may collect cultivation information including a quantity of light, a temperature, pH, a concentration of microalgae, an oxygen concentration, a carbon concentration, humidity, and the like and may transmit the collected cultivation information to the control device 180 through wired communication.

The sensor unit 120 is a component connected to the control device 180 in a wired manner and performs the same operation as the sensor unit 120 of FIG. 1, and thus a detailed description thereof will be omitted.

The actuator unit 130 may be connected to the control device 180 in a wire manner and may operate according to an instruction transmitted from the control device 180 through wired communication.

The actuator unit 130 may generate an environment for culturing microalgae by operating at least one of a light source, a heater, a stirrer, an ultrasonic generator, and a pH regulator 136 according to an instruction from the control device 180.

The actuator unit 130 is a component connected to the control device 180 in a wired manner and performs the same operation as the actuator unit 130 of FIG. 1, and thus a detailed description thereof will be omitted.

The gas supply unit 140 may be connected to the control device 180 in a wired manner and may operate according to an instruction transmitted from the control device 180. That is, a pneumatic pump 144, an impurity removal filter, and a gas measuring sensor 143 of the gas supply unit 140 may operate according to a control instruction of the control device 180.

For example, the pneumatic pump 144 of the gas supply unit 140 may operate according to a control instruction transmitted from the control device 180 through wired communication, thereby allowing gas flowing into a gas pipe 145 to be supplied to a culture medium 10 inside the cultivation vessel 110.

The gas measuring sensor 143 may sense a state of gas flowing into the gas pipe 145 and may transmit sensed gas state information to the control device 180 through wired communication.

The impurity removal filter may remove impurities from inflowing gas by being operated according to an instruction transmitted from the control device 180 through wired communication.

The microalgae collection device 160 may be connected to the control device 180 in a wired manner and may operate under the control of the control device 180 to collect microalgae cultured in the cultivation vessel 110.

The microalgae collection device 160 may be installed at an upper portion of the cultivation vessel 110 such that at least a portion thereof is located outside the cultivation vessel 110.

The microalgae collection device 160 may include a housing 161, a transfer tube 162, a transfer pump 164, a filtering chamber 165, a filter supply roller 169, a filter collection roller 170, and a rotary motor 171.

The housing 161 may accommodate the filtering chamber 165, the filter supply roller 169, and the filter collection roller 170 therein. The housing 161 may be a closed housing that is isolated from the external atmosphere.

The housing 161 may be manufactured in any one shape of a box shape, a container shape, a raceway shape, a rectangular parallelepiped shape, a barrel shape, a cylinder shape, and a polygonal column shape, but the present invention is not necessarily limited thereto. Housings with various shapes that can be used in the art may be applied to the housing 161. The housing 161 may be made of a material having excellent mechanical strength, water resistance, and chemical resistance.

The transfer tube 162 may be formed to move the culture medium 10 in the cultivation vessel 110 to the filtering chamber 165.

One end portion of the transfer tube 162 may be connected to the cultivation vessel 110, and the other end portion thereof may be connected to the filtering chamber 165. The transfer tube 162 may be provided in the form of a tube through which the culture medium 10 may flow.

The transfer pump 164 may be installed on the transfer tube 162 outside the housing 161 and may allow the culture medium 10 to move to the filtering chamber 165 through the transfer tube 162.

The transfer pump 164 may operate under the control of the control device 180 to move the culture medium 10 cultured in the cultivation vessel 110 to the filtering chamber 165 through the transfer tube 162. That is, the transfer pump 164 may operate under the control of the control device 180 to allow the culture medium 10 of the cultivation vessel 110 to flow into a transfer tube inlet 163 and move to the filtering chamber 165 through the transfer tube 162. The filtering chamber 165 may be filled with the culture medium 10 transferred through the transfer tube 162 by gravity.

As the transfer pump 164, any known pump or device capable of moving the culture medium 10 may be applied without limitation.

The filtering chamber 165 may be installed inside the housing 161 and may collect microalgae from the culture medium 10 supplied through the transfer tube 162. The filtering chamber 165 may have a space that allows microalgae to be collected from the culture medium 10.

The filtering chamber 165 may include a filter 166, a collection port 167, and a support 168.

The filter 166 may be installed at a lower portion (bottom) of the filtering chamber 165 and may filter microalgae from the culture medium 10 supplied through the transfer tube 162.

The filter 166 may filter microalgae from the culture medium 10 supplied through the transfer tube 162 and may allow the culture medium 10, from which the microalgae have been filtered, to pass therethrough.

The filter 166 may be a sheet-shaped filter having different pores (pore sizes) according to types (sizes) of microalgae. For example, the filter 166 may be a filter made of a sheet material having pores with a size in a range of several tens of nanometers to several micrometers. Since microalgae have various sizes in a range of several tens of nanometers to several micrometers, the pores may be smaller than the microalgae.

The filter 166 may be made of a material such as paper or plastic. In addition, the filter 166 may be made of a material having pores through which microalgae cannot pass. The filters 166 may include, for example, a HEPA filter.

The collection port 167 may be a component that moves the culture medium 10, from which microalgae have been removed through the filter 166, into the cultivation vessel 110. That is, the filter 166 may filter microalgae from the culture medium 10, and the culture medium 10 from which the microalgae have been removed may pass through the filter 166 and move to the collection port 167 by gravity and a capillary force.

The support 168 may be installed in an area below the filter 166 excluding the collection port 167.

The filter 166 installed at the lower portion (bottom) of the filtering chamber 165 may be disposed on the support 168, and the support 168 may be installed to prevent sagging of the filter 166 and allow the culture medium 10, from which microalgae have been removed, to smoothly pass through the collection port 167.

The filter supply roller 169 may be installed inside the housing 161 and may supply the filter 166 to the filtering chamber 165.

The filter collection roller 170 may be installed inside the housing 161 and may collect the filter of the filtering chamber 165.

The rotary motor 171 may be installed at the filter collection roller 170 and may operate under the control of the control device 180 to move the filter from the filter supply roller 169 to the filter collection roller 170. That is, the filter may be wound around the filter supply roller 169 and, when necessary, may be moved from the filter supply roller 169 to the filter collection roller 170 by the rotary motor 171 installed at the filter collection roller 170.

Meanwhile, the capacity of the filter capable of collecting microalgae is predetermined. Thus, when the filter collects microalgae in an amount that is greater than or equal to a certain capacity (standard capacity), pores of the filter may be clogged, and when the pores of the filter are clogged, the microalgae collection efficiency of the filter may be decreased.

Accordingly, the control device 180 may calculate the total amount of microalgae filtered by the filter, and the filter of the filtering chamber 165 may be replaced based on the calculated total amount of microalgae.

That is, the control device 180 may calculate the total amount of microalgae filtered by the filter based on a concentration of microalgae included in the culture medium 10 in the cultivation vessel 110 and a flow rate of the transfer pump 164. Here, the concentration of microalgae may be a concentration of microalgae that is included in the culture medium 10 and is measured through an optical sensor (light sensor) installed in the cultivation vessel 110. The flow rate of the transfer pump 164 may be a preset value and may be changed.

When the total amount of filtered microalgae is calculated, the control device 180 may determine whether the calculated total amount of microalgae is greater than or equal to a preset standard capacity. When the total amount of microalgae is greater than or equal to the standard capacity, the control device 180 operates the rotary motor 171 to move the filter of the filtering chamber 165 toward the filter collection roller 170, thereby replacing the filter of the filtering chamber 165.

When the total amount of filtered microalgae is not greater than or equal to the standard capacity, the control device 180 may not replace the filter.

When the filter of the filter supply roller 169 is exhausted, the control device 180 may output or transmit a notification signal, which is for collecting microalgae from the filter wound around the filter collection roller 170, to a manager (user).

That is, the control device 180 may determine whether the filter of the filter supply roller 169 is exhausted by using the number of times of filter collection of the filter collection roller 170, a length of a filter collected by the filter collection roller 170, or the like. When it is determined that the filter of the filter supply roller 169 is exhausted, the control device 180 may output or transmit a notification signal, which is for collecting microalgae from the filter wound around the filter collection roller 170, to a manager (user).

When the filter of the filter supply roller 169 is not exhausted, without collecting the filter wound around the filter collection roller 170, the control device 180 may continuously monitor whether a microalgae collection condition is satisfied.

The filter collected in a state of being wound around the filter collection roller 170 may undergo subsequent treatment of collecting useful materials from microalgae. In this case, the filter may be selectively removed through a physical or chemical method to leave only microalgae. A process of collecting useful materials from collected microalgae may include a process of extracting hydrocarbons, proteins and lipids from microalgae using various methods including such as heating, acid treatment, enzymatic digestion, sonication, or dissolution.

FIG. 4 is a view illustrating a wireless microalgae cultivation apparatus according to another embodiment of the present invention. FIG. 5 is a view illustrating a microalgae collection device shown in FIG. 4.

Referring to FIG. 4, a wireless microalgae cultivation apparatus 100 according to one embodiment of the present invention includes a cultivation vessel 110, a sensor unit 120, an actuator unit 130, a gas supply unit 140, a gas discharge portion 150, a microalgae collection device 160, and a control device 180.

The cultivation vessel 110, the sensor unit 120, the actuator unit 130, the gas supply unit 140, and the gas discharge portion 150 perform the same operations as the cultivation vessel 110, the sensor unit 120, the actuator unit 130, the gas supply unit 140, and the gas discharge portion 150 shown in FIG. 2, and thus a description thereof will be omitted.

The microalgae collection device 160 may be installed inside the cultivation vessel 110.

The microalgae collection device 160 may be connected to the control device 180 in a wireless manner and may operate under the control of the control device 180 to collect microalgae cultured in the cultivation vessel 110.

The microalgae collection device 160 may include a housing 161, a buoyancy material 172, a transfer tube 162, a transfer pump 164, a filtering chamber 165, a filter supply roller 169, a filter collection roller 170, a rotary motor 171, and a wireless controller 173.

The housing 161, the transfer tube 162, the transfer pump 164, the filtering chamber 165, the filter supply roller 169, the filter collection roller 170, and the rotary motor 171 perform the same operations as the housing 161, the transfer tube 162, the transfer pump 164, the filtering chamber 165, the filter supply roller 169, the filter collection roller 170, and the rotary motor 171 shown in FIG. 3, and thus a description thereof will be omitted.

The buoyancy material 172 may be installed below the housing 161 and may allow the housing 161 to float above the culture medium 10.

The buoyancy material 172 may be installed at each of both sides of the housing 161 with respect to the filtering chamber 165 and may allow the microalgae collection device 160 to float above the culture medium 10.

As the buoyancy material 172, a portion for maintaining buoyancy, such as Styrofoam, a buoy, a piece of wood, a transparent glass tube, or a plastic container, may be used. A material of the buoyancy material 172 may be Teflon (polytetrafluoroethylene), polyolefin, polyamide, polyacrylate, silicone, polymethyl methacrylate, polystyrene, an ethylene-vinyl acetate copolymer, a polyethylene-maleic anhydride copolymer, polyamide, poly(vinyl chloride), poly(vinyl fluoride), polyvinyl imidazole, chlorosulphonate polyolefin, polyethylene terephthalate (PET), nylon, low density polyethylene (LDPE), high density polyethylene (HDPE), acrylic, polyetheretherketone, polyimide, polycarbonate, polyurethane, or poly(ethylene oxide).

The wireless controller 173 may perform wireless communication with the control device 180 and may wirelessly receive an instruction for controlling the rotary motor 171 and the transfer pump 164 in the filtering chamber 165 from the control device 180.

The wireless controller 173 may be connected to the transfer pump 164 and the rotary motor 171 in a wired manner and may transmit a control instruction of the control device 180.

FIG. 6 is a schematic block diagram illustrating a configuration of a control device according to one embodiment of the present invention.

Referring to FIG. 6, a control device 180 according to one embodiment of the present invention may include a communication module 181, a memory 182, and a processor 183.

The memory 182 is a component that stores pieces of data related to the operation of the control device 180. In particular, the memory 182 may store a program (application or applet) that enables an optimal cultivation environment to be generated based on cultivation information collected through a sensor unit 120, a program (application or applet) that enables microalgae to be collected based on the collected cultivation information, or the like, and pieces of stored information may be selected by the processor 183 as needed.

In addition, the memory 182 stores various types of data generated in a process of executing an operating system or program (application or applet) for driving the control device 180. In this case, the memory 182 is a general term for a nonvolatile storage device that continuously maintains stored information even when power is not supplied, and a volatile storage device that requires power to maintain stored information.

In addition, the memory 182 may perform a function of temporarily or permanently storing data processed by the processor 183. Here, the memory 182 may include a magnetic storage medium or a flash storage medium in addition to the volatile storage device that requires power to maintain stored information, but the scope of the present invention is not limited thereto.

The communication module 181 may be a component for communication between the control device 180 and other electronic devices (a sensor unit 120, an actuator unit 130, a gas supply unit 140, a microalgae collection device 160, a management server, and the like) through a communication network and may be implemented in hardware using an RF system-on-chip (SoC). The communication module 181 may be implemented in various forms such as a short-range communication module, a wireless communication module, a mobile communication module, and a wired communication module. However, the present invention is not limited to the above-described communication methods, and various communication methods may be adopted to transmit information.

The processor 183 may be configured to control the overall operation of the control device 180. For example, the processor 183 may execute software (for example, a program) stored in the memory 182 to control a component connected to the processor 183 (for example, at least one component of the memory 182 and the communication module 181). The processor 183 may be implemented as an application specific integrated circuit (ASIC), a digital signal processor (DSP), a programmable logic device (PLD), a field programmable gate array (FPGA), a central processing unit (CPU), and/or a microcontroller, but the present invention is not limited thereto.

The processor 183 may control the actuator unit 130 and the gas supply unit 140 to generate an initial cultivation environment such as a temperature, pH, light source radiation, and gas supply in a cultivation vessel 110 in a state in which a culture medium 10 is put into the cultivation vessel 110.

When the culture medium 10 is put, the processor 183 may control the gas supply unit 140 and the actuator unit 130 to generate an initial cultivation environment or an optimal cultivation environment.

Specifically, the processor 183 may control the gas supply unit 140 to supply external gas to the culture medium 10 in the cultivation vessel 110. That is, the processor 183 may control the gas supply unit 140 so that an initial or optimal cultivation environment in the cultivation vessel 110 is generated based on cultivation information collected through the sensor unit 120. Here, the cultivation information may include a quantity of light, a temperature, pH, a concentration of microalgae, an oxygen concentration, a carbon concentration, humidity, and the like. In this case, the processor 183 may operate a pneumatic pump 144 of the gas supply unit 140 to allow gas to flow in through a gas inlet port 141 and allow the inflowing gas to move to a gas supply port 146 through a gas pipe 145 to be supplied to the culture medium 10 inside the cultivation vessel 110.

The processor 183 may control the actuator unit 130 to control a temperature, light radiation, pH, or the like inside the cultivation vessel 110. In this case, the processor 183 may control the actuator unit 130 such that an initial or optimal cultivation environment inside the cultivation vessel 110 is generated based on cultivation information collected through the sensor unit 120. The processor 183 may operate a heater, a light source, a stirrer, an ultrasonic generator, a pH regulator, or the like to generate an initial or optimal cultivation environment.

When the initial cultivation environment is generated, a user (operator) may put microalgae to the culture medium 10.

When microalgae are put into the culture medium 10, the processor 183 may collect cultivation information through the sensor unit 120.

When cultivation information is collected, the processor 183 may determine whether the collected cultivation information satisfies a preset microalgae collection condition. Here, the microalgae collection condition may include whether a concentration of microalgae in the culture medium 10 measured through the sensor unit 120 (for example, an optical sensor) is greater than or equal to a preset reference concentration.

For example, when light does not pass through the optical sensor well, it can be confirmed that a concentration of microalgae is high, and when light passes through the optical sensor well, it can be confirmed that a concentration of microalgae is low. Accordingly, the processor 183 may check a concentration of microalgae based on a degree of transmission of light through the optical sensor.

When the cultivation information satisfies the microalgae collection condition, the processor 183 may control the microalgae collection device 160 to collect microalgae.

That is, the processor 183 may operate a transfer pump 164 of the microalgae collection device 160 to move the culture medium 10 cultured in the cultivation vessel 110 to a filtering chamber 165 through a transfer tube 162. In this case, the filtering chamber 165 may be filled with the culture medium 10 transferred through the transfer tube 162 by gravity.

A filter installed at a lower portion of the filtering chamber 165 in the microalgae collection device 160 may filter microalgae from the culture medium 10 supplied through the transfer tube 162. That is, the filter may filter microalgae from the culture medium 10 supplied through the transfer tube 162 and may allow the culture medium 10, from which the microalgae have been filtered, to pass therethrough.

Meanwhile, the capacity of the filter capable of collecting microalgae is predetermined. Thus, when the filter collects microalgae in an amount that is greater than or equal to a certain capacity, pores of the filter may be clogged, and when the pores of the filter are clogged, the microalgae collection efficiency of the filter may be decreased.

Accordingly, the processor 183 may calculate the total amount of microalgae filtered by the filter, and the filter of the filtering chamber 165 may be replaced based on the calculated total amount of microalgae.

That is, the processor 183 may calculate the total amount of microalgae filtered by the filter based on a concentration of microalgae included in the culture medium 10 in the cultivation vessel 110 and a flow rate of the transfer pump 164. Here, the concentration of microalgae may be a concentration of microalgae that is included in the culture medium 10 and is measured through an optical sensor (light sensor) installed in the cultivation vessel 110. The flow rate of the transfer pump 164 may be a preset value and may be changed.

When the total amount of filtered microalgae is calculated, the processor 183 may determine whether the calculated total amount of microalgae is greater than or equal to a preset standard capacity. When the total amount of microalgae is greater than the standard capacity, the processor 183 operates a rotary motor 171 to move the filter of the filtering chamber 165 to a filter collection roller 170, thereby replacing the filter of the filtering chamber 165. That is, the processor 183 may operate the rotary motor 171 installed in the filter collection roller 170 to move the filter from a filter supply roller 169 to the filter collection roller 170.

When the filter of the filter supply roller 169 in the microalgae collection device 160 is exhausted, the processor 183 may output or transmit a notification signal, which is for collecting the filter wound around the filter collection roller 170 to collect microalgae, to an administrator (user). In this case, the processor 183 may determine whether the filter of the filter supply roller 169 is exhausted by using the number of times of collection of the filter collection roller 170, a length of a filter collected by the filter collection roller 170, or the like.

Meanwhile, the control device 180 according to the present embodiment may further include an output module (not shown) that outputs a notification signal for providing a notification to collect microalgae.

The output module may output microalgae collection notification information or the like under the control of the processor 183. The output module may be implemented as a display, a printer, a speaker, or the like. Here, the display may be implemented as, for example, a thin film transistor-liquid crystal display (TFT-LCD) panel, an LED panel, an organic LED (OLED) panel, an active matrix OLED (AMOLED) panel, or a flexible panel.

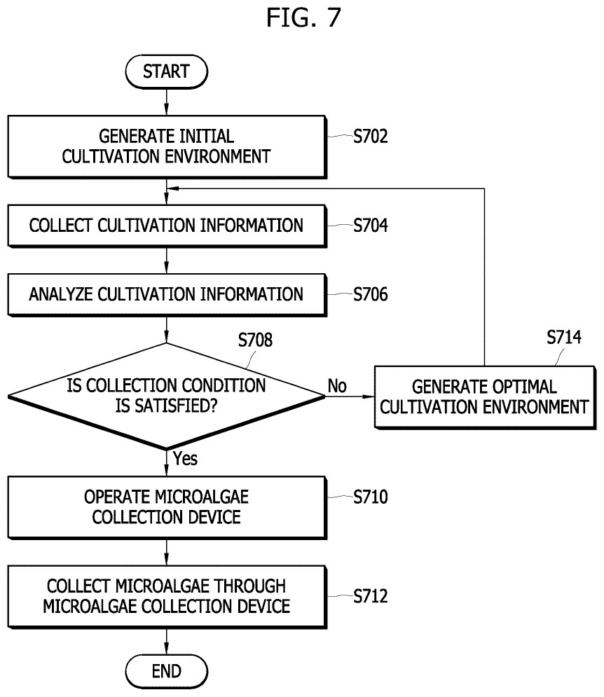

FIG. 7 is a view for describing a microalgae cultivation method according to one embodiment of the present invention.

Referring to FIG. 7, when microalgae are put into an initial cultivation environment (S702), a control device 180 collects cultivation information through a sensor unit 120 (S704). That is, when a culture medium 10 is put into a cultivation vessel 110 and the initial cultivation environment is generated by a certain temperature, pH, light radiation, gas supply, or the like being provided, microalgae to be cultured may be put into the cultivation vessel 110 to start culture.

The control device 180 may control a gas supply unit 140 and an actuator unit 130 to control gas, a temperature, light radiation, pH, or the like inside the cultivation vessel 110.

The control device 180 may collect cultivation information including a quantity of light, a temperature, pH, a concentration of microalgae, an oxygen concentration, a carbon concentration, humidity, or the like in the cultivation vessel 110 through the sensor unit 120 in real time or periodically.

When operation S704 is performed, the control device 180 analyzes the collected cultivation information (S706) and determines whether a preset microalgae collection condition is satisfied (S708). That is, the control device 180 may determine whether the concentration of microalgae of the cultivation information is greater than or equal to a preset standard concentration. When the concentration of microalgae is greater than or equal to the standard concentration, the control device 180 may determine that the microalgae collection condition is satisfied.

When the microalgae collection condition is satisfied as a determination result in operation S708, the control device 180 operates a microalgae collection device 160 (S710) and performs control such that microalgae is collected through the microalgae collection device 160 (S712).

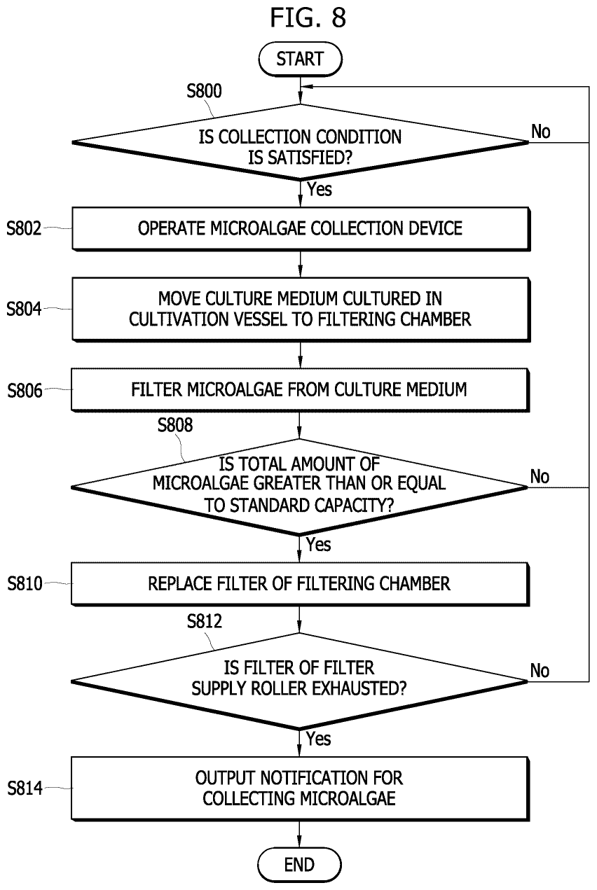

For a detailed description of a method by which the microalgae collection device 160 collects microalgae, reference is made to FIG. 8.

When the microalgae collection condition is not satisfied as the determination result of operation S708, the control device 180 controls a gas supply unit 140 and an actuator unit 130 to generate an optimal cultivation environment (S714) and perform operation S704.

FIG. 8 is a flowchart for describing a microalgae collection method according to one embodiment of the present invention.

Referring to FIG. 8, when cultivation information satisfies a preset microalgae collection condition (S800), a control device 180 operates a microalgae collection device 160 (S802) to move a culture medium 10 cultured in a cultivation vessel 110 to a filtering chamber 165 through a transfer tube 162 (S804). That is, the control device 180 may operate a transfer pump 164 of the microalgae collection device 160 to move the culture medium 10 cultured in the cultivation vessel 110 to the filtering chamber 165 through the transfer tube 162. In this case, the filtering chamber 165 may be filled with the culture medium 10 transferred through the transfer tube 162 by gravity.

When operation S804 is performed, a filter installed at a lower portion of the filtering chamber 165 in the microalgae collection device 160 filters microalgae from the culture medium 10 supplied through the transfer tube 162 (S806). That is, the filter may filter microalgae from the culture medium 10 supplied through the transfer tube 162 and may allow the culture medium 10, from which the microalgae have been filtered, to pass therethrough.

When operation S806 is performed, the control device 180 determines whether a total amount of microalgae filtered by the filter is greater than or equal to a standard capacity (S808). That is, the capacity of the filter capable of collecting microalgae is predetermined. Thus, when the filter collects microalgae in an amount that is greater than or equal to a certain capacity, pores of the filter may be clogged, and when the pores of the filter are clogged, the microalgae collection efficiency of the filter may be decreased.

Accordingly, the control device 180 may determine whether the total amount of microalgae filtered by the filter is greater than or equal to a preset standard capacity. In this case, the control device 180 may calculate the total amount of microalgae filtered by the filter based on a concentration of microalgae included in the culture medium 10 in the cultivation vessel 110 and a flow rate of the transfer pump 164. Here, the concentration of microalgae may be a concentration of microalgae that is included in the culture medium 10 and is measured through an optical sensor (light sensor) installed in the cultivation vessel 110. The flow rate of the transfer pump 164 may be a preset value and may be changed.

When the total amount of microalgae is greater than or equal to the standard capacity as a determination result in operation S808, the control device 180 operates a rotary motor 171 to move the filter of the filtering chamber 165, thereby replacing the filter of the filtering chamber 165 (S810). That is, the control device 180 operates the rotary motor 171 installed in a filter collection roller 170 so that the filter may be moved from a filter supply roller 169 to the filter collection roller 170.

When operation S810 is performed, the control device 180 determines whether the filter of the filter supply roller 169 in the microalgae collection device 160 is exhausted (S812). In this case, the control device 180 may determine whether the filter of the filter supply roller 169 is exhausted by using the number of times of collection of the filter collection roller 170, a length of a filter collected by the filter collection roller 170, or the like.

When it is determined in operation S812 that the filter of the filter supply roller 169 is exhausted, the control device 180 outputs or transmits a notification signal, which is for collecting the filter wound around the filter collection roller 170 to collect microalgae, to a manager (user) (S814).

When the filter of the filter supply roller 169 is not exhausted as a determination result in operation S812, the control device 180 performs operation S800.

When the total amount of microalgae is not greater than or equal to the standard capacity as a determination result in operation S808, the control device 180 performs operation S800.

As described above, according to one aspect of the present invention, in the present invention, it is possible to collect and analyze cultivation (growth) information of microalgae in real time and optimize cultivation (growth) conditions (environment) for various microalgae based on analysis results, thereby obtaining an effect of enabling increases in efficiency and economic feasibility of microalgae cultivation (growth).

In addition, according to one aspect of the present invention, when cultivation (growth) information collected through a sensor unit satisfies a preset microalgae collection condition, microalgae are collected through a microalgae collection device, thereby obtaining an effect of maintaining the homeostasis and stability of microalgae cultivation (growth) and enabling continuous microalgae collection.

In addition, according to one aspect of the present invention, a filter in which microalgae are collected is moved to a filter collection roller, and a new filter is supplied to a filtering chamber through a filter supply roller 169, thereby obtaining an effect of enabling continuous collection of microalgae without clogging of the filter.

While the exemplary embodiments of the present disclosure and their advantages have been described in detail, it should be understood that various changes, substitutions and alterations may be made herein without departing from the scope of the present disclosure. Therefore, the embodiments described above are illustrative in all aspects and should not be understood as limiting the present disclosure.

What is claimed is:

1. A microalgae cultivation apparatus comprising:
a cultivation vessel which has a cultivation space for accommodating a culture medium and cultivates microalgae therein;
a gas supply unit configured to supply gas to the cultivation vessel;
a gas discharge portion configured to discharge gas that has passed through the culture medium of the cultivation vessel;
a sensor unit installed inside the cultivation vessel;
an actuator unit installed inside the cultivation vessel;
a microalgae collection device configured to collect the microalgae cultured in the cultivation vessel; and
a control device configured to control at least one of the gas supply unit, the gas discharge portion, and the actuator unit to generate an environment for cultivating the microalgae, collect cultivation information through the sensor unit, and control the microalgae collection device to collect the microalgae based on the collected cultivation information.

2. The microalgae cultivation apparatus of claim 1, wherein the gas supply unit includes:
a gas pipe which is coupled to the cultivation vessel, has at least a portion located inside the cultivation vessel, and supplies external gas to the cultivation vessel;
a gas sensing chamber which is installed outside the cultivation vessel and includes a gas measuring sensor configured to sense a state of gas flowing into the gas pipe; and
a pneumatic pump installed outside the cultivation vessel and configured to allow the gas flowing into the gas pipe to flow out to the culture medium in the cultivation vessel.

3. The microalgae cultivation apparatus of claim 2, wherein the gas supply unit further includes an impurity removal filter installed at a front end portion of the gas sensing chamber outside the cultivation vessel and configured to remove impurities from the gas flowing into the gas pipe.

4. The microalgae cultivation apparatus of claim 1, wherein a lower area of the cultivation vessel is filled with the culture medium including the microalgae, and
an upper area of the cultivation vessel is filled with the gas that has passed through the culture medium.

5. The microalgae cultivation apparatus of claim 1, wherein the sensor unit includes at least one of a temperature sensor, a dissolved oxygen sensor, a dissolved carbon sensor, a pH sensor, a humidity sensor, and a light sensor.

6. The microalgae cultivation apparatus of claim 1, wherein the actuator unit generates the environment for cultivating the microalgae by operating at least one of a light source, a heater, a stirrer, an ultrasonic generator, and a pH regulator installed inside the cultivation vessel under control of the control device.

7. The microalgae cultivation apparatus of claim 1, wherein the control device is connected to at least one of the gas supply unit, the sensor unit, the actuator unit, and the microalgae collection device in a wired manner.

8. The microalgae cultivation apparatus of claim 7, wherein the microalgae collection device is installed at an upper portion of the cultivation vessel such that at least a portion of the microalgae collection device is located outside the cultivation vessel.

9. The microalgae cultivation apparatus of claim 8, wherein the microalgae collection device includes:
a housing;
a filtering chamber installed inside the housing;
a transfer tube formed to move the culture medium in the cultivation vessel to the filtering chamber; and
a transfer pump installed outside the housing and configured to allow the culture medium to move to the filtering chamber through the transfer tube,
wherein the filtering chamber includes:
a filter configured to filter the microalgae from the culture medium supplied through the transfer tube; and
at least one collection port configured to move the culture medium, from which the microalgae have been removed through the filter, into the cultivation vessel.

10. The microalgae cultivation apparatus of claim 9, wherein the filter is installed at a lower portion inside the filtering chamber, and
a support is installed below the filter and is installed in an area excluding the collection port.

11. The microalgae cultivation apparatus of claim 9, wherein the microalgae collection device further includes:
a filter supply roller installed inside the housing and configured to supply the filter to the filtering chamber;
a filter collection roller installed inside the housing and configured to collect the filter of the filtering chamber; and
a rotary motor installed at the filter collection roller and configured to move the filter from the filter supply roller to the filter collection roller under control of the control device.

12. The microalgae cultivation apparatus of claim 11, wherein the control device
calculates a total amount of the microalgae filtered by the filter based on a concentration of the microalgae included in the culture medium in the cultivation vessel and a flow rate of the transfer pump, and
when the calculated total amount of the microalgae is greater than or equal to a preset standard capacity, operates the rotary motor to move the filter in the filtering chamber so that the filter of the filtering chamber is replaced.

13. The microalgae cultivation apparatus of claim 1, wherein, when a concentration of the microalgae included in the cultivation information is greater than or equal to a preset standard concentration, the control device controls the microalgae collection device to collect the microalgae.

14. The microalgae cultivation apparatus of claim 1, wherein the microalgae collection device is installed inside the cultivation vessel and connected to the control device in a wireless manner, and
at least one of the gas supply unit, the sensor unit, and the actuator unit is connected to the control device in a wired manner.

15. The microalgae cultivation apparatus of claim 14, wherein the microalgae collection device includes:
a housing;
a buoyancy material installed below the housing and configured to allow the housing to float above the culture medium;
a filtering chamber installed inside the housing;
a transfer tube formed to move the culture medium in the cultivation vessel to the filtering chamber;
a transfer pump installed outside the housing and configured to allow the culture medium to move to the filtering chamber through the transfer tube; and
a wireless controller configured to perform wireless communication with the control device and receive a control signal for controlling the rotary motor and the transfer pump in the filtering chamber from the control device in a wireless manner,
wherein the filtering chamber includes:
a filter configured to filter the microalgae from the culture medium supplied through the transfer tube; and
at least one collection port configured to move the culture medium, from which the microalgae have been removed through the filter, into the cultivation vessel.

16. The microalgae cultivation apparatus of claim 15, wherein the filter is installed at a lower portion inside the filtering chamber, and
a support is installed below the filter and is installed in an area excluding the collection port.

17. The microalgae cultivation apparatus of claim 15, wherein the microalgae collection device includes:
a filter supply roller installed inside the housing and configured to supply the filter to the filtering chamber;
a filter collection roller installed inside the housing and configured to collect the filter of the filtering chamber; and
a rotary motor installed at the filter collection roller and configured to move the filter from the filter supply roller to the filter collection roller under control of the control device.

18. A microalgae cultivation method comprising:
controlling, by a control device, at least one of a gas supply unit and an actuator unit to generate a microalgae cultivation environment;
determining whether a preset microalgae collection condition is satisfied by analyzing, by the control device, cultivation information collected through a sensor unit; and
when the microalgae collection condition is satisfied, controlling, by the control device, a microalgae collection device to collect microalgae.

19. The microalgae cultivation method of claim 18, wherein, in the determining, when a concentration of the microalgae of the cultivation information is greater than or equal to a preset standard concentration, the control device determines that the microalgae collection condition is satisfied.

20. The microalgae cultivation method of claim 18, wherein the controlling further comprises:
moving, by the control device, a culture medium cultured in a cultivation vessel to a filtering chamber of the microalgae collection device and performing control such that the microalgae is filtered from the culture medium through a filter installed at a lower portion of the filtering chamber;
when a total amount of the microalgae filtered by the filter is greater than or equal to a preset standard capacity, moving, by the control device, the filter of the filtering chamber to a filter collection roller to replace the filter of the filtering chamber; and
when the filter of the filter supply roller is exhausted, outputting, by the control device, notification information for collecting the microalgae from the filter wound around the filter collection roller.
